(19) United States
(12) Patent Application Publication
(10) Pub. No.: US 2014/0180631 A1
(43) Pub. Date: Jun. 26, 2014

(54) CONTACT SENSOR

(71) Applicant: R&D CORE LIMITED, Leatherhead (GB)

(72) Inventor: Thomas Papakostas, Leatherhead (GB)

(73) Assignee: R&D CORE LIMITED, Leatherhead (GB)

(21) Appl. No.: 14/136,577

(22) Filed: Dec. 20, 2013

(30) Foreign Application Priority Data
Dec. 21, 2012 (GB) 1223230.2

(51) Int. Cl. G01B 21/00

(52) U.S. Cl. CPC G01B 21/00
USPC 702/150

(57) ABSTRACT

A method of detecting a contact 300 using a contact sensor having an array of discrete and spaced apart sensing elements 102, 202 comprises: measuring the value of a parameter and, when the measured value of the parameter varies between a first value and a second value with the variation being indicative of a partial and/or intermittent contact with an adjacent sensor element, determining an estimated value for the parameter intermediate the first value and the second value.

This application claims priority to United Kingdom Patent Application No. 1223230.2 filed Dec. 21, 2012, incorporated hereby reference in its entirety.

The present disclosure relates to a method for detecting a contact using a contact sensor and to a contact sensor for performing the method. In particular, improving the apparent spatial resolution of a contact sensor. Contact sensors or touch pads are used in numerous applications. They typically utilize a tactile sensor or an array of tactile sensors in combination with hardware or software processing to provide an indication of a contact by the user. The contact can be made by a finger or using a stylus or it can be any other kind of contact area. For example a computer touch pad, as used on laptop computers in place of a mouse, detects contact by a user's finger and provides information relating to the location of the contact and movement of the contact point. This information can be used by the computer to control a cursor on screen or to perform other functions. In another example, such a contact sensor can be used to measure the size of a human foot by measuring the length and width of a foot contact.

Various types of contact sensors are available. Pressure sensing contact sensors operate by determining a contact in accordance with the pressure applied at the contact area. This type of contact sensor is to be distinguished from capacitive type sensors and other sensors relying on a change in electrical field properties that arise when there is contact at the contact surface. Other types of contact sensor include piezoresistive, piezoelectric, and optical (infrared beams, LEDs) sensors.

A typical pressure sensor utilizes multiple layers of interdigitated conductive traces, with adjacent layers having traces perpendicular to the traces of a facing layer. When a pressure is applied the traces on opposing layers come into contact and hence form an electrically conductive pathway. U.S. Pat. No. 4,587,378 discloses an example of such a sensor in the context of a touch tablet. Measurement of a contact point in U.S. Pat. No. 4,587,378 is achieved by applying a reference voltage to one layer and measuring the output from the other layer. Other systems are also known in the prior art, including the other sensor types referenced above, many of which utilize discrete and spaced apart sensor elements to provide an indication of the location and in some cases also the area of a contact on the sensing surface.

Viewed from a first aspect, the disclosure provides a method of detecting a contact using a contact sensor having an array of discrete and spaced apart sensing elements, the method comprising: measuring the value of a parameter and, when the measured value of the parameter varies between a first value and a second value with the variation being indicative of a partial and/or intermittent contact with an adjacent sensor element, determining an estimated value for the parameter intermediate the first value and the second value.

In one example embodiment the parameter may vary by fluctuating between the first value and the second value with the fluctuation being indicative of intermittent contact at the adjacent sensor element or at adjacent sensor elements. In this example the parameter varies in a generally ‘digital’ way, being either at the first value, which might for example indicate a contact with an adjacent sensor element, or at the second value, which might for example indicate a lack of contact with an adjacent sensor element.

In another example embodiment the parameter may take a value in between the first value and the second value, and in addition the parameter may vary with time, hence forming a variable value between the first value and the second value. In this example the parameter varies in a continuous, analogue fashion, and could possibly take any value between the two end points.

With any kind of contact sensor (for example, a pressure sensor, capacitive sensor, piezoresistive sensor, piezoelectric sensor or optical sensor) using discrete and separate sensor elements that produce a digital indication of the location, length and/or area of a contact on the sensor then there is always a limit on resolution due to the need for physical spacing of the sensing elements. The output of the sensor, which may be the parameter referenced above, can indicate that the contact is at a particular location or of a certain size, and the accuracy of this output is limited by the physical resolution of the sensing elements, and hence by the size of and spacing of the sensing elements. In the context of the current disclosure the parameter is a value produced by the sensor that represents, or can be used to derive, the location and/or the size of a contact on the sensor. Thus the parameter may represent the sensing element(s) actuated or triggered by the contact. In prior art systems the sensor is limited by the spacing of the sensor elements. It is desirable to increase the measurement resolution of sensors with discrete and separate sensor elements without increasing the sensor's physical spatial resolution, since this will allow coarser spacing of sensing elements to provide a finer measurement of a contact and since this will also permit an increase in resolution even when the number of and spacing of the sensing elements is limited by technological capabilities or by other factors, such as the cost of manufacture.

The inventor has found that when the contact or an edge of the contact is in-between two sensing elements then there can be a partial and/or intermittent contact with the sensing elements giving rise to a varying parameter as discussed above. This may be an intermittent contact of one or both sensing elements resulting in the sensor output fluctuating between two neighboring values. Alternatively it may be a partial contact providing a continuously varying sensor output, which may for example take the form of a varying resistance or other electrical parameter. The method set out above is based on the realization that this variation of the parameter, for example the fluctuation between two values, can be used to increase the apparent resolution of the sensor beyond the physical resolution provided by the spacing of the sensor elements. This can for example be based on the assumption that a fluctuation and/or a continuous variation is indicative of a contact with a parameter that lies between the two values, such as a contact area with a boundary between two of the discrete sensor elements.

The parameter may, for example, be an electrical signal or measurement based on an electrical signal. It may be or may represent a resistance value, a capacitance value, a voltage value, a current value or any other parameter used in contact sensors. The exact nature of the parameter is not important provided that the contact sensor has an output that changes depending on the number and/or location of sensor elements that are triggered by a contact. This output, or measurements/data derived from it, can form the parameter.

A variation or fluctuation in the parameter may arise when there is a human input behind the contact on the sensor, even when the contact appears to be stationary. This is because a contact applied by a person inevitably has small variations, for example due to muscular motions, breathing or heartbeat or due to medical conditions, for example when a person's foot standing on a contact sensor cannot stand still in an effort to maintain the body's balance. Some sensors will be more likely to produce a variation that is generally ‘digital’, or at least can be approximated as digital. Other sensors will be more likely to produce an output that varies in analogue fashion, or at least can be reliably approximated as such. The different behaviors are affected not only by the sensor type (e.g. resistive, capacitive, piezoelectric and so on) but also by the sensor's design such as the spacing between the sensing elements and the behavior of these sensing elements, for example their force sensitivity or their minimum force threshold.

In some cases the behavior of the sensor may act as a combination of the two systems, where sometimes the parameter shows a digital change and also sometimes the parameter varies continuously. In that instance a combination of the methods described herein may be usefully applied, for example by taking an average of multiple sampled values over a time period, as described below.

In some example embodiments, when the parameter varies by fluctuating between the first value and the second value then the method includes identifying a fluctuation between the first and second values as being a transition from one value to the other and then back again. A straightforward transition from one value to another would hence not be considered an intermittent contact. The fluctuation may be a fluctuation between activating a first sensor element and activating a second, adjacent, sensor element. Alternatively it may be a fluctuation between activating a first sensor element and actuating the first sensor element in combination with activating a second, adjacent, sensor element.

In a simple system the estimated value might simply be set to be the mid-point of the first value and the second value. However, in one example, a calculation is made in order to allow the estimated value to be set to any point between the first value and the second value. The determination of the estimated value can be based on the duration of time that the parameter spends at the first value and the duration of time that the parameter spends at the second value in a given time interval. It will be appreciated that this ‘digital’ example may require measurements to be taken over a time period in order for an accurate estimate to be given, although depending on the speed of the fluctuation the time period can be very short.

The estimated value may be determined by calculating a weighted mean of the first and second values of the parameter, weighted by the duration spent at the first and second values, according to the following equation:

$$〈 X 〉 = \frac{{X}_{1} {t}_{1} + {X}_{2} {t}_{2}}{{t}_{1} + {t}_{2}}$$

where <X> is the estimated value of the parameter, X₁ is the first value, X₂ is the second value, and t₁ and t₂ are the cumulative durations at each of the first and second values, respectively, during a given time interval. Alternative calculations may be made using the cumulative durations at the first and second values. In one example, the calculation can take into account known properties of the sensor, for example the method may include calculation of the estimated value using a formula derived from empirical testing of the sensor.

It will be understood that when a contact is moving then there will be a transition between values. It is possible that a fluctuating movement between first and second values could be caused by a contact that moves from one point to another and then back again. Hence, in preferred embodiments the time interval is set so as to distinguish between a moving contact and an intermittent contact. Thus, the time interval may be set to be small enough to distinguish between a ‘flickering’ intermittent contact and a fluctuation caused by motion of the contact on the sensor. The minimum time that it would take for a moving contact to go from one value to another will depend on the purpose of the contact sensor. For touch pads and other contact sensors reacting to finger or hand movements a time interval of 0.1 seconds may be appropriate, since it would not be expected for the contact to deliberately move between values that quickly and therefore a fluctuation between two values occurring in 0.1 seconds or less can fairly be assumed to be a result of an intermittent contact. The actual time interval can be programmable as a function of the application and/or the user. The time interval may be a function of the distance between the sensor elements, i.e. the resolution. For example, for a sensor with resolution of 2 mm a time interval of 0.1 seconds may be appropriate, whereas for a sensor with 0.5 mm resolution, a time interval of 0.01 seconds may be more appropriate.

When the parameter takes the form of a variable value between the first value and the second value, then the method may include taking just a single measurement of the parameter, and determining the estimated value based on this measurement. This can give a ‘snapshot’ of the state of the sensor, and provided that noise can be avoided in the sensor system (for example in electrical output from the sensor and/or in the scanning and controlling electronics) this will be an accurate value. Thus, this method provides the possibility for an effectively instantaneous measurement that will increase the apparent resolution of the sensor.

However, it may also be advantageous to consider an average of values over time, which allows for smoothing of noise in the system and also will average out any variations caused by variations in the force of the contact on the sensor. Thus, the method may include taking multiple measurements of the parameter over a time period and determining the estimated value by taking an average of the measurements, preferably a mean average.

The variable value for the parameter may be at any point between the first value (which may represent no contact with a sensing element) and the second value (which may represent a full contact with the sensing element).

The contact may be any one of a contact point, a line contact or a contact area. Typically a contact can be characterised as a two dimensional contact area, since a true point contact or one dimensional line contact may not be practically possible. However when the contact area is smaller than the resolution of the sensor then it may appear like a point or one dimensional contact. The parameter may be indicative of a length of the contact. Alternatively, the parameter may be indicative of a location of a point contact or of an end point of a contact area or line contact. The advantages of the proposed method for increasing the apparent resolution of the sensor apply with any parameter.

The method may include determining an estimated location for a contact based on an assumption that there is a linear characteristic for the variation in the parameter, and hence based on converting the estimated value for the parameter into a location for a contact based on a linear scale between the two sensing elements concerned. For example, in the situation where the parameter varies along a continuum between the first value and the second value, then the estimated value for the parameter can be converted directly into a location value by using a linear equation, whose slope is defined by the two values and the physical distance between the corresponding sensing elements, to provide a location between the corresponding first and second sensing elements. Alternatively, the method may include use of a non-linear conversion to take account of a non-linear behavior of a sensor. For example the parameter may be found to vary slowly and stay near to the first value with a contact close to a first sensing element, and then pass through a transition zone to the second value only when the contact is at a mid-point between the first sensing element and second sensing element.

It will further be understood that for some sensors there may be multiple parameters and that the method can be applied to each of these multiple parameters. In a preferred method the parameter is a first parameter and the method further comprises: measuring the value of a second parameter and, when the measured value of the second parameter varies (fluctuates) between a first value and a second value with the variation being indicative of partial and/or intermittent contact at adjacent sensor elements, determining an estimated value intermediate the first and the second value. A third parameter and yet further parameters could optionally be treated in the same way, for example to provide increased resolution when measuring the location of a number of points about the periphery of a contact area.

In one example, the first and second parameters can represent measurements in each of two co-ordinates. The parameters measured in each of the two co-ordinates may be used to determine a contact area. The method hence provides a way to increase the apparent resolution of a sensor when measuring the size of a contact area. The co-ordinates can be orthogonal, for example an x and y co-ordinate system for measurement of a contact location and/or area.

Depending on the magnitude of the variation in pressure or location of a contact on the sensor and on the spacing of the sensing elements it may be possible for the parameter to fluctuate between more than two values, for example fluctuating between three or more adjacent values, including first and second values as endpoints, and intermediate values representing intermediate sensing elements. It will be appreciated that the method described above encompasses this possibility and can easily be extended to make a calculation of an estimated value based on a variation between more than two values for more than two sensing elements. Hence, in an embodiment, when the measured value of the parameter varies between a set of more than two values with the variation being indicative of partial and/or intermittent contact at adjacent sensor elements, the method includes determining an estimated value for the parameter based on the duration of time that the parameter spends at each individual value of the more than two values in a given time interval.

As noted above the method can be advantageously applied to any contact sensor where the output is a digital indication of a contact location and/or area measured by discrete and spaced apart sensor elements. It will be understood that the spacing of the sensor elements is a physical spacing along the sensing surface of the sensor. In preferred embodiments the contact sensor comprises discrete electrical elements formed in an array and arranged to provide a measurable change in electrical properties when there is a contact with a sensing surface of the contact sensor. The contact sensor may be capacitive or alternatively it may use a physical/mechanical system where movement of elements of the sensor results in changes to an electrical circuit within the sensor.

In examples of the second type of sensor, using a physical system, the sensor may comprise a layer with sensing elements in the form of multiple conductive traces located adjacent to further conductive parts and arranged so that a contact on a sensing surface of the sensor completes an electrical circuit involving one or more of the conductive traces, whereby the location and/or area of the contact can be determined by identifying the traces that are involved. To provide a two dimensional measurement system the sensor may include two sets of multiple conductive traces overlaid on one another and at an angle to one another, preferably orthogonal to one another.

In one example, the contact sensor comprises: a first insulative layer; a second insulative layer; a first resistor strip on the first insulative layer; a second resistor strip on the second insulative layer; a plurality of first conductive traces provided on the first insulative layer and electrically connected to the first resistor strip; and a plurality of second conductive traces provided on the second insulative layer and electrically connected to the second resistor strip, wherein the first insulative layer and second insulative layer face each other such that the plurality of first conductive traces face the plurality of second conductive traces with each of the first conductive traces extending across the plurality of second conductive traces and each of the second conductive traces extending across the plurality of first conductive traces thereby forming an array of points of intersection of the first and second conductive traces, wherein the first insulative layer and second insulative layer are spaced apart such that there is no electrical contact between the plurality of first and second conductive traces when a contact is not applied to the contact sensor, and wherein when a contact is applied there is an electrical contact between at least one of each of the plurality of first and second conductive traces in a region of the contact. The plurality of first and second conductive traces in this arrangement form the discrete and spaced apart sensor elements.

With this arrangement a contact area may be measured by the effect it has on electrical properties of the resistor strip. The pressure applied by the contact will result in the traces of one layer shorting one or more traces of the other layer. This means that electrical properties measured at the resistor strip, such as the apparent resistance of the resistor strip, will be changed, since a portion of the resistor strip is shorted out due to the contact of the traces.

According to another aspect of the disclosure, there is provided a contact sensor apparatus for carrying out the method disclosed above. Thus, the disclosure provides a contact sensor apparatus comprising an array of discrete/spaced out sensing elements; and a processor; wherein the processor is arranged to measure the value of a parameter and, when the measured value of the parameter varies between a first value and a second value with the variation being indicative of partial and/or intermittent contact at adjacent sensor elements, to determine an estimated value for the parameter intermediate the first value and the second value.

In certain examples of the apparatus, the processor may be arranged to carry out any or all of the preferred method steps set out above.

The specific operation of the method will now be explained with reference to an exemplary sensor, which is the subject of co-pending UK Patent application No. 1221915.0 and co-pending International (PCT) Patent Application No. PCT/GB2013/053214 both of which are incorporated fully by reference herein. In the following, the general principles of operation of the exemplary sensor are set out, and then the application of the present disclosure to the exemplary sensor is described. However, it should be understood that the method is not limited to the exemplary sensor. In particular, the disclosure is not limited to a pressure sensor as described in the following example. The method can also be used with any of the other types of sensor identified in the foregoing discussion, and is more generally applicable to any sensor with a broadly similar structure (for example, comprising conductive traces in a sensing area or any other type of discrete and spaced apart sensing elements).

The exemplary sensor and certain examples of the present disclosure will now be described in greater detail by way of example only and with reference to the following drawings in which:

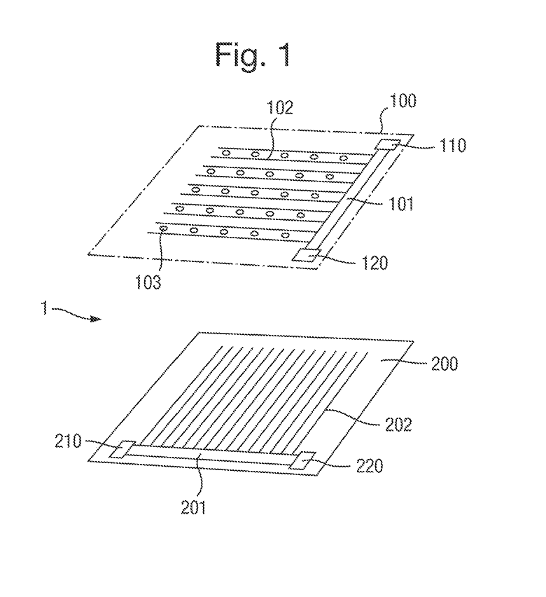

FIG. 1 is a schematic exploded perspective view of a two-dimensional contact sensor having discrete and spaced apart sensor elements;

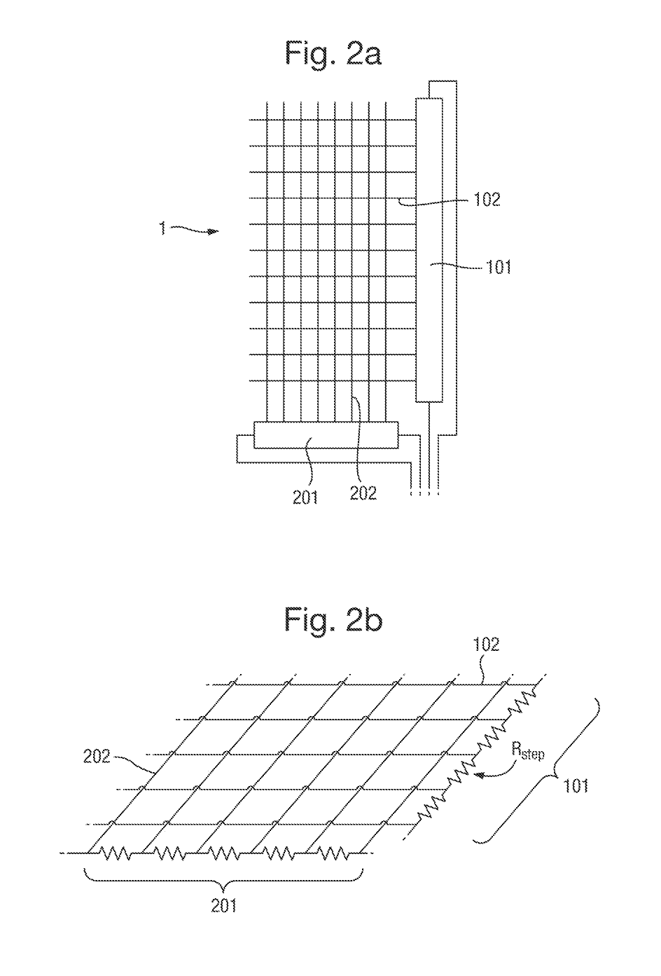

FIG. 2a is a schematic plan view of the contact sensor of FIG. 1;

FIG. 2b shows an equivalent electrical circuit of the contact sensor of FIG. 1;

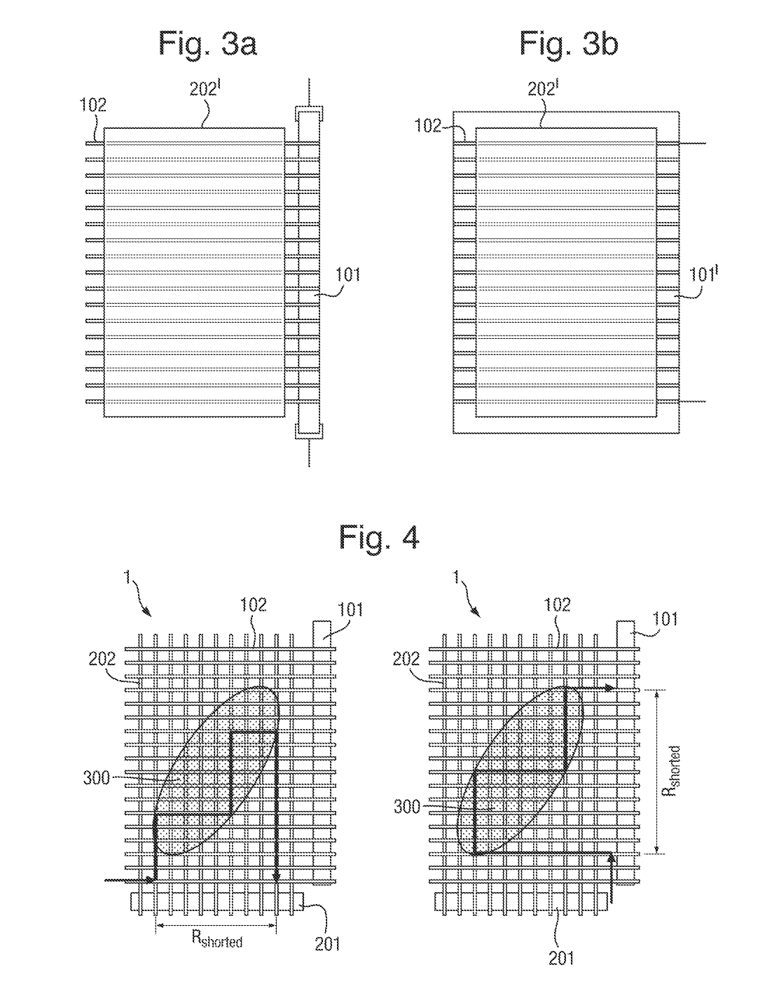

FIG. 3a shows a one-dimensional sensor;

FIG. 3b shows an alternative one-dimensional sensor;

FIG. 4 is a schematic illustrating an example contact sensor similar to the sensor shown in FIG. 1 with a contact applied;

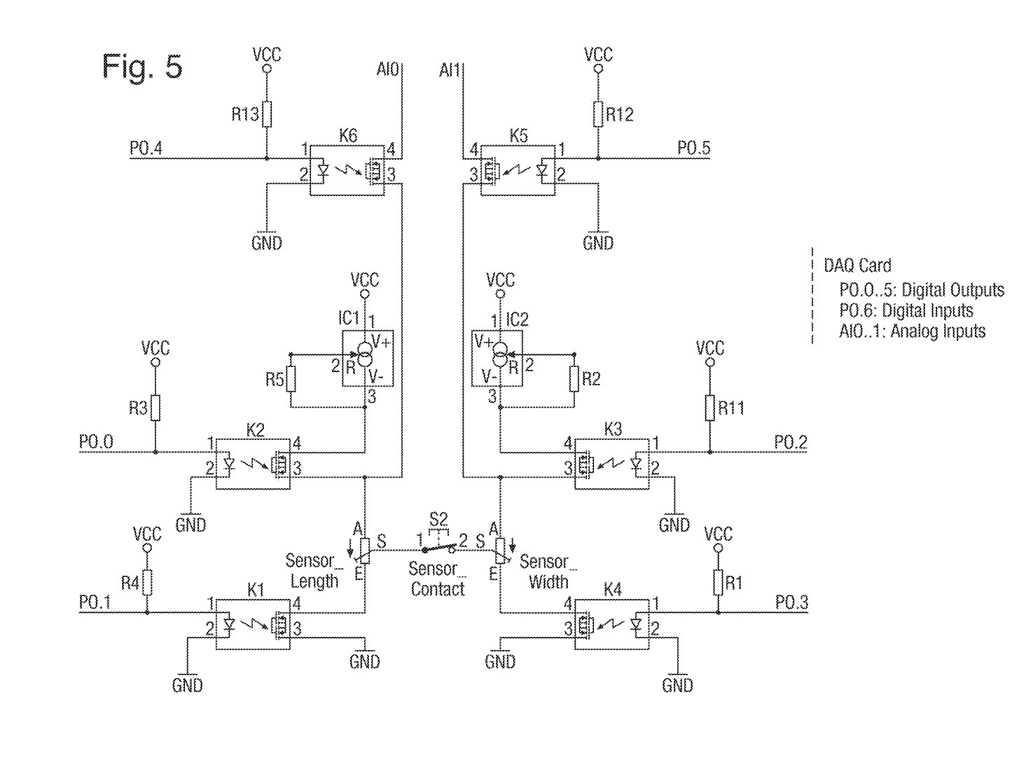

FIG. 5 shows a circuit design for the exemplary contact sensor;

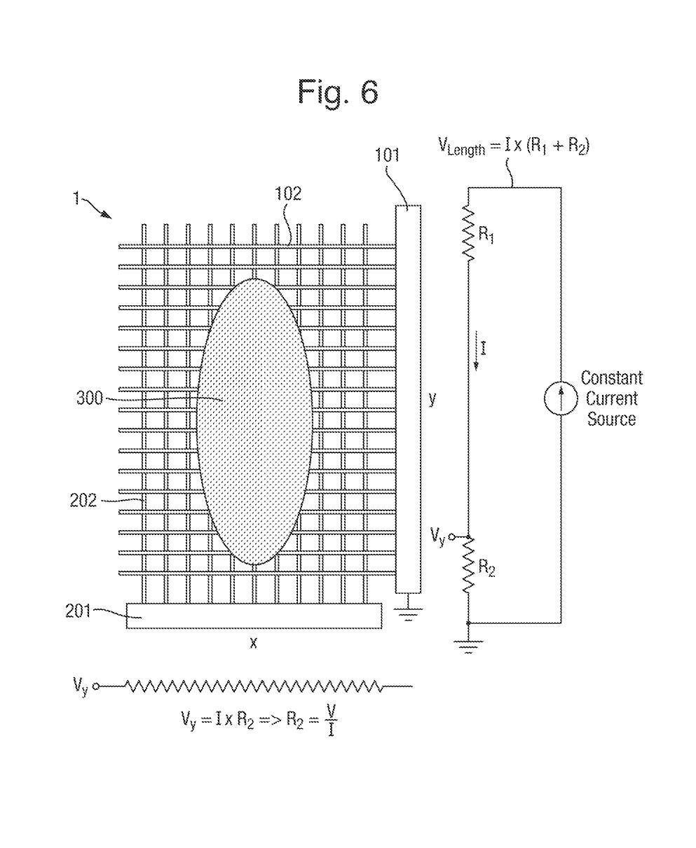

FIG. 6 shows measurement of the contact length and position in one dimension for the sensor of FIG. 4;

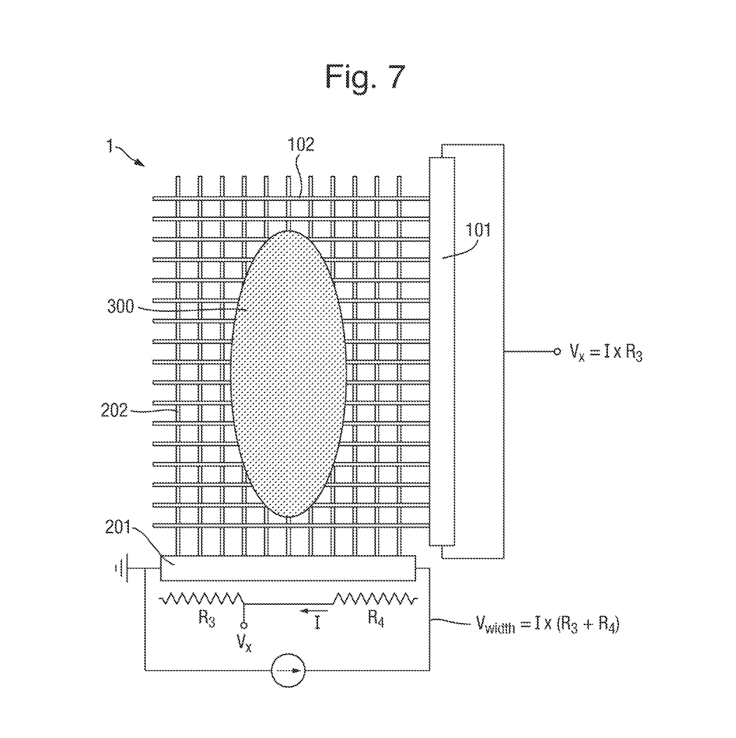

FIG. 7 shows measurement of the contact length and position in the other dimension for the sensor of FIG. 4;

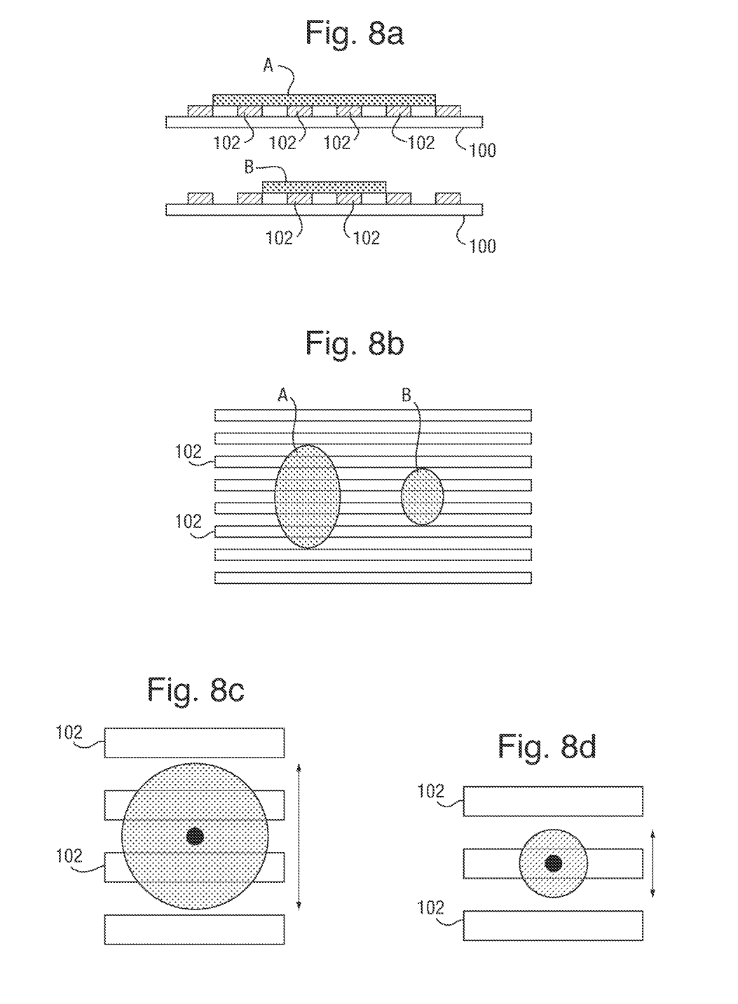

FIGS. 8a and 8b show two contacts with different area, shorting the same number of electrodes in one dimension;

FIGS. 8c and 8d illustrate difficulties in determining the size of a contact area when it is small in comparison to the spacing of the sensor elements;

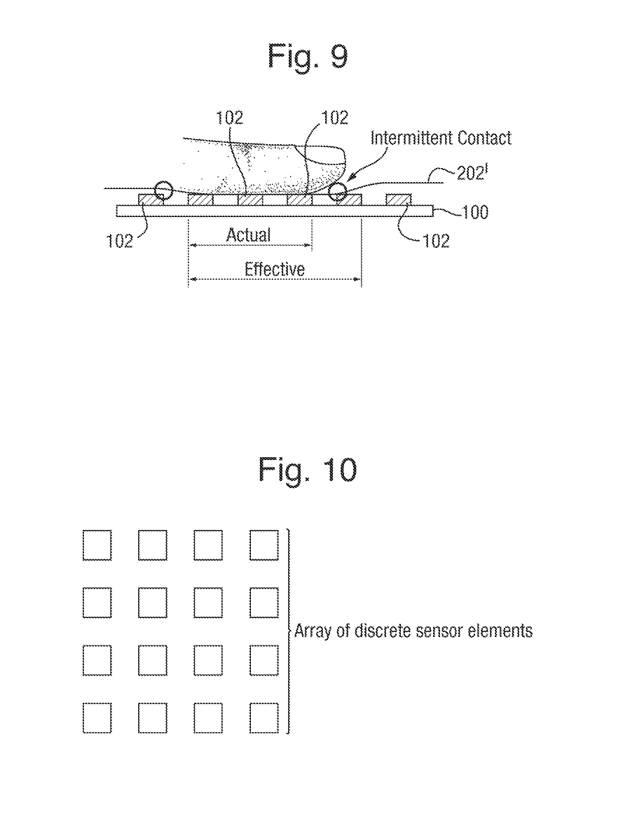

FIG. 9 shows intermittent contact with an electrode at one end of a finger contacting a contact sensor;

FIG. 10 shows another example of an array of discrete sensor elements;

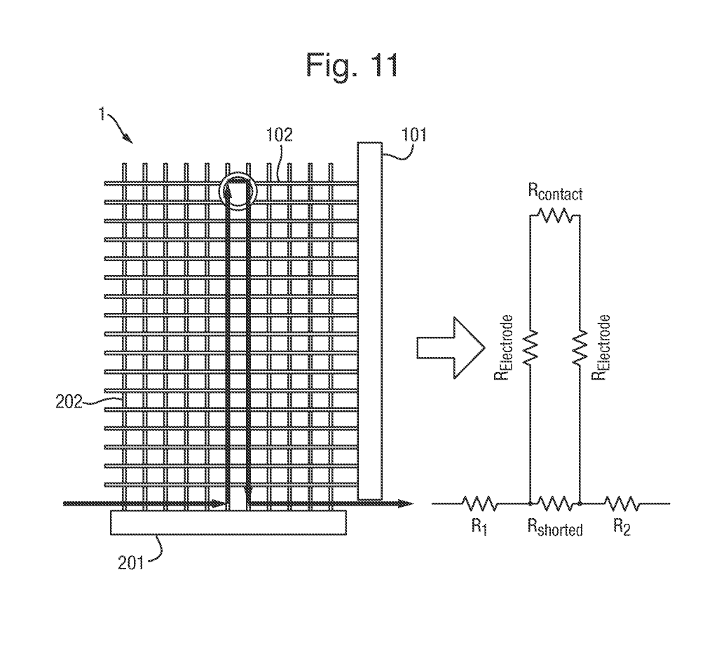

FIG. 11 is a diagram used to explain the effect of a partial contact creating a variable resistor effect;

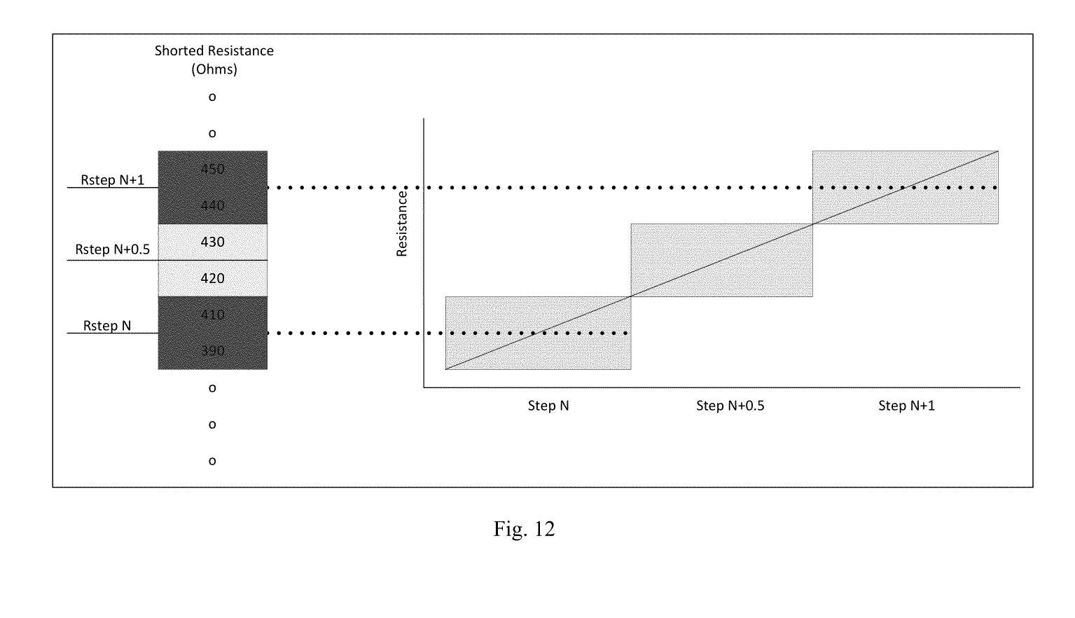

FIG. 12 shows division of a spacing between sensor elements into notional higher resolution resistance steps; and

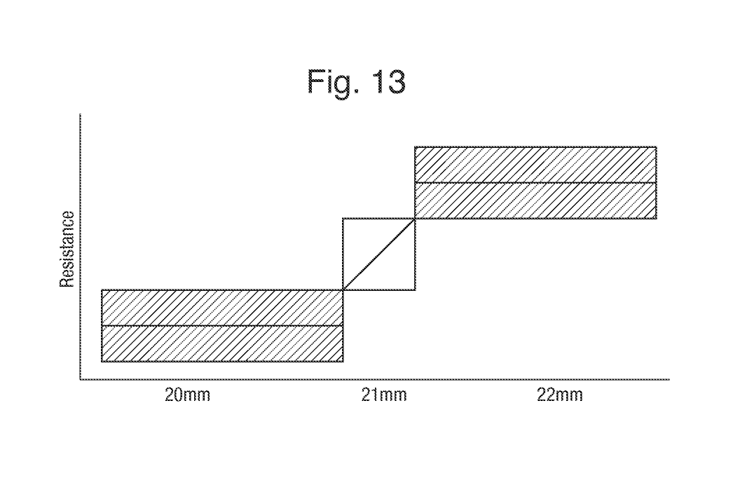

FIG. 13 shows a similar division adjusted for a non-linear behavior.

In the following description of various example structures in accordance with the disclosure, reference is made to the accompanying drawings, which form a part hereof, and in which are shown by way of illustration of various structures in accordance with this disclosure. Additionally, it is to be understood that other specific arrangements of parts and structures may be utilized, and structural and functional modifications may be made without departing from the scope of the present disclosure.

With reference to FIG. 1, the exemplary contact sensor 1 comprises two electrically insulative layers (substrates). In particular, the contact sensor comprises a first layer 100 and a second layer 200. Each layer 100, 200 carries an array of parallel (or nearly parallel) conductive traces 102, 202, which extend across the layer 100, 200 away from a respective resistor strip 101, 201. The conductive traces 102, 202 divide the resistor strips 101, 201 into equally sized resistor steps, Rₛₜₑₚ (see FIG. 2b). Thus, Rₛₜₑₚ is the resistance of the resistor strip between two adjacent conductive traces.

The two ends of each of the resistor strips 101, 201 are connected to electrodes 110,120 and 210, 220 respectively. The electrodes are provided for connection to an electronic circuit.

As shown in FIG. 2a, the two layers are assembled together so that the conductive traces 102 on the first layer 100 face the conductive traces 202 on the second layer 200, and the conductive traces on one layer are at an angle to the conductive traces on the other layer. The conductive traces 102, 202 on both layers therefore form an array, or grid, of points of intersection, which forms the sensing area. The equivalent electrical circuit is shown in FIG. 2b.

In order to resiliently space apart the first and second layers 100, 200, a spacer structure 103, in this case spacer dots, can be provided on one or both layers between or on the conductive traces 102, 202 (see FIG. 1). The spacer structure 103 helps the first and second plurality of conductive traces 102, 202 to remain electrically isolated from each other when no contact is applied to the sensor. It is also possible to provide the spacer structure 103 as lines or a pattern around the conductive traces. Features of the spacer structure 103 will affect the threshold of the force needed to make the two layers contact each other. The tighter the spacer pattern 103 and the greater its height, the greater the force needed to register a contact at the points of intersection of the first and second conductive traces. Of course, to keep the two layers 100, 200 separated, the spacer pattern 103 has to be thicker than the depth of the conductive traces 102, 202.

FIG. 3a shows a simplified version of the sensor that can be produced by replacing one half of the sensor with a continuous conductive layer 202′, e.g. a metallic foil. When a contact is applied, this layer 202′ will short the conductive traces 102 on the other half of the sensor, thereby allowing the measurement of a contact in one dimension only by measuring the change in resistance across the resistor strip 101.

An alternative exemplary one-dimensional sensor is shown in FIG. 3b, which shows a sensor in which the resistor strip is provided as a resistor layer 101′. Thus, the resistor strip (layer) can extend all the way into the sensing area. The benefit of this design is that the sensing area can cover nearly the whole width of the sensor device leaving a very small margin all around for the adhesive and the electrode traces to be routed to the connector. This creates a nearly borderless sensor.

To measure the location/area of the contact in the one-dimensional sensor, a resistance meter is placed across the ends of the resistor strip 101. The change in resistance on application of a contact is proportional to the length of the contact. The resistance between the conductive layer 202′ and each of the ends of the resistor strip 101 is then measured. The resistance measured is proportional to the distance of the contact area from each end.

FIG. 4 shows a simplified example of a two-dimensional sensor that is similar to that of FIG. 1. As shown in FIG. 4, when a contact 300 is applied to the contact sensor, the conductive traces 102 of the first layer 100 touch the conductive traces 202 of the bottom layer 200 in the region of the contact 300, making an electrical contact (i.e. a short). A segment of the resistor strip 101 on the first layer 100 will be shorted by the conductive traces 202 of the second layer. Likewise, a segment of the resistor strip 201 on the second layer will be shorted by the conductive traces 102 of the first layer. The lengths of the shorted segments correspond to the length and width of the contact area 301.

The contact area is defined by the points of intersection at which the contact 300 causes an electrical contact between the first and second plurality of conductive traces 102, 202. As shown in FIG. 4, the contact sensor 1 measures the maximum dimensions projected to their respective resistor strips. In essence, the contact sensor measures the outline of the smallest possible orthogonal 301 that encapsulates the whole contact 300.

There are a number of modes that the contact sensor 1 can be operated in: the resistive mode and the wiper mode. These will be discussed in further detail below with reference to FIGS. 5 to 7.

### Resistive Mode

In the resistive mode, it is possible to measure the size, but not the location, of the contact area 301.

When a contact 300 is applied to the contact sensor 1, the change in the resistance of the resistor strips 101, 201 will be a monotonic function, usually a near-linear function, of the contact length and width as projected to the corresponding resistor strip 101, 201. One of the resistor strips 101 determines one of the dimensions of the contact area 301 (length or width) and the other resistor strip 201 determines the other dimension. When the resistance of one of the two strips is measured, the other strip needs to be electrically isolated so that it does not introduce any parasitic voltages/currents to the first strip, which can affect the measured resistance.

For each resistor strip:

$$\begin{matrix}{R}_{CONTACT} = ρ \frac{{Length}_{TOTAL} - {Length}_{CONTACT}}{wt} \\ = k ( {Length}_{TOTAL} - {Length}_{CONTACT} )\end{matrix} \qquad ( 1 )$$

R_{CONTACT} is the resistance of the resistor strip 101, 201 after a contact is made, ρ is the resistivity of the resistor strip, Length_{TOTAL} is physical length of the resistor strip in question, Length_{CONTACT} is the length or width of contact area 300, w is the resistor strip's width, t is the resistor's thickness and k=ρ/wt.

The factor k may vary due to manufacturing tolerances of the resistor strip's resistivity ρ and thickness t. Nonetheless, the contact sensor 1 can be self-calibrated by using the following ratio approach:

R_{TOTAL}=k(Length_{TOTAL}) (2)

where R_{TOTAL} is the total resistance of the resistor strip 101, 201 in question, i.e. without a contact applied.

$$\frac{{R}_{CONTACT}}{{R}_{TOTAL}} = \frac{{Length}_{TOTAL} - {Length}_{CONTACT}}{{Length}_{TOTAL}} \qquad ( 3 )$$

and therefore:

$${Length}_{CONTACT} = {Length}_{TOTAL} ( 1 - \frac{{R}_{CONTACT}}{{R}_{TOTAL}} ) \qquad ( 4 )$$

Length_{TOTAL} is known (per the manufacturing specs). Therefore, measuring the pre-load initial resistance (R_{TOTAL}) of the resistor strip 101, 201 and its resistance when a contact 300 is applied, the contact length (Length_{CONTACT}) can be calculated.

It is apparent that the contact sensor 1 is self-calibrated since the contact length/width measurements are based on the ratio of the resistance values before and after the contact 300 is applied. This is very useful when the initial resistance of the strip 101, 201 can vary due to manufacturing tolerances, varying ambient conditions such as temperature and humidity, ageing, etc. The contact sensor 1 is therefore immune to the precision and/or stability of the resistor strip 101, 201, which reduces the manufacturing cost and increases the contact sensor's accuracy.

It is likely that the resistance of the discrete steps (Rₛₜₑₚ) can be affected by environmental changes such as temperature or humidity, or by ageing, etc. Nonetheless, as long as the effect is not localized, all steps will change similarly along with the total resistance of each strip 101, 201. Since all measurements capture the relative change in resistance, the contact sensor 1 is intrinsically immune to the effects of these variables.

The resistance can be measured with different circuits, e.g. voltage divider, resistance to voltage op-amp converter, resistance to frequency converter such as the 555 timer or a square wave relaxation oscillator, etc. For reasons of accuracy and simplicity a constant current source was used to apply a constant current to one resistor strip 101, 201 at a time. The longer the segment of the resistor strip that is shorted, the smaller the total resistance; therefore, the measured voltage will be lower as well, given that the current is constant. Therefore:

$$\begin{matrix}{V}_{TOTAL} = {IR}_{TOTAL} & ( 5 ) \\ {V}_{CONTACT} = {IR}_{Contact} & ( 6 ) \\ \frac{{V}_{CONTACT}}{{V}_{TOTAL}} = \frac{{R}_{CONTACT}}{{R}_{TOTAL}} & ( 7 )\end{matrix}$$

Substituting the above ratio in Equation (4):

$${Length}_{CONTACT} = {Length}_{TOTAL} ( 1 - \frac{{V}_{CONTACT}}{{V}_{TOTAL}} ) \qquad ( 8 )$$

Referring to FIG. 5, when the relays K1 and K2 are on, one end of the one of the resistor strips 101 is attached to the CCS and the other end is grounded. Relay K6 is then turned on to connect the output of the CCS to an Analogue to Digital Converter (Data Acquisition Card). The voltage measured is directly proportional to the resistance of the resistor strip 101. The other resistor strip 201 is floating; therefore it does not introduce any parasitic voltages to the resistor strip 101 being measured.

To measure the other resistor strip 201, K1 and K2 are turned off and K3 and K4 are turned on. K5 is turned on and the voltage at the output of the second CCS is captured by a second analogue input on the DAQ card.

There is an alternative method. In a perfectly uniform resistor strip 101, 201, all resistor steps Rₛₜₑₚ will have the same value. In this case, when a contact short-circuits n resistor steps, the reduction of the strip's resistance will be nRₛₜₑₚ. By measuring the drop in the resistance, the length of the contact 300 (in either direction) can be easily calculated as follows:

$${R}_{TOTAL} - {R}_{CONTACT} = {nR}_{step} ⇒ n = \frac{{R}_{TOTAL} - {R}_{CONTACT}}{{R}_{step}} \qquad ( 9 )$$

Given that the contact sensor resolution is known (the conductive trace pitch); the contact length can be calculated:

Length_{CONTACT}=n×resolution (10)

With the appropriate scanning method (referred to herein as the wiper mode), the sensor can be used to measure both the contact area and the position of the contact area on the sensor.

### Wiper Mode

The contact area 301 can be calculated based on the resistance measurements of the two resistor strips 101, 201, as outlined above.

Referring to FIGS. 6 and 7, as an example, consider finding the location of the contact along the first resistor strip, 101. Whilst constant current I is supplied by the constant current source across the first resistor strip 101, a high impedance voltage measuring circuit can be attached to any part of the resistor/conductive trace pattern on the second layer 200. The second layer acts as a wiper electrode to identify the location of the contact across the first resistor strip 101.

Specifically, to measure the voltage drop V_{y} across resistor R₂:

$${V}_{y} = {IR}_{2} ⇒ {R}_{2} = \frac{{V}_{y}}{I} \qquad ( 11 )$$

Therefore,

$$\frac{{V}_{y}}{{V}_{TOTAL}} = \frac{{R}_{2}}{{R}_{TOTAL}} = \frac{{Length}_{END}}{{Length}_{TOTAL}} \qquad ( 12 )$$

where Length_{END} is the distance of the end of the contact area from the end of the resistor strip 101 and V_{TOTAL} is the voltage drop across the resistor strip when unloaded.

The circuit described above in relation to the resistive mode (see FIG. 5) can also be used in the wiper mode. Specifically, when the first resistor strip 101 is being measured (K1=K2=K6=On), the conductive traces 202 on the other sensor layer 200 can be connected to the 2^{nd} ADC and capture the voltage drop between the end of the contact on the first resistor strip 101 and its ground. Specifically, K3=K4=Off but K5=On. Since the input of the ADC is a high impedance one, this connection draws very little, if any, current. Therefore, it does not affect the resistance measurement of the first resistor strip 101. Reversing the process, the circuit can then measure the voltage drop between the end of the contact area 301 in the second resistor strip 201 and its ground. In essence, there are two voltage measurements per strip, one for the resistance and one for the position of the contact across its respective dimension. Hence, both the contact area 301 and the position can be determined.

The size of the contact area 301 can also be measured using the wiper method (instead of the resistance method). Specifically, V_{y} measured resistance R₂. By reversing the current flow on the Length resistor, V_{y} will measure the voltage drop across resistor R₁; therefore R₁ can be measured as well. From this information, the length of the contact itself can be calculated. Also, if V_{CONTACT} and one of R₁ or R₂ are known, then the other resistance (other end of contact) can be determined using Equation (6).

### Resolution of the Exemplary Contact Sensor

The centre-to-centre spacing between the conductive traces in each direction defines the measuring resolution, rₛₑₙₛₒᵣ, in each direction, e.g. for 1 mm wide traces with 1 mm spacing between them, the measuring resolution is 2 mm, which results in a contact measurement accuracy of ±1 mm.

In addition, the gap between the conductive traces affects the minimum resistor step Rₛₜₑₚ; the smaller the gap, the smaller the Rₛₜₑₚ. Given that the measuring circuitry must have a resolution of at least Rₛₜₑₚ (assuming the parasitic resistances are negligible) to be able to detect the minimum change, the smaller the Rₛₜₑₚ, the more demanding the specifications for the circuitry become. Therefore, the higher the resolution is (tighter spacing between the conductive traces), the greater the resistance of the resistor strip should be. This can be achieved by manufacturing a thinner strip (in width and/or thickness) and/or by using a material with a larger resistivity ρ.

It will be appreciated that with a system having discrete and separate sensor elements like this system, where a contact is measured by an essentially digital indication of a location or contact area, then there is always a limit on resolution due to the need for physical spacing of the sensing elements. Whilst technological advances have permitted manufacturing of sensors with finer resolution it will never be possible to generate a completely analogue measuring system. It is desirable to increase the length/width measurement resolution of sensors with discrete and separate sensor elements, such as this example sensor, without increasing the sensor's physical spatial resolution, since this will allow coarser spacing of sensing elements to provide a finer measurement of a contact and since this will also permit an increase in resolution even when the number of and spacing of the sensing elements is limited by technological capabilities or by other factors, such as the cost of manufacture.

This applies with the example sensor architecture described herein and also applies with any other sensor where the sensing of location of a point contact or of characteristics of a contact area is based on measurements taken using discrete and spaced out sensing elements (see for example FIG. 10). The method described herein can hence be adapted for any other contact sensor of this type, such as the contact sensors of U.S. Pat. No. 4,587,378, U.S. Pat. No. 4,963,702, U.S. Pat. No. 5,503,029 or U.S. Pat. No. 5,623,760, for example.

For a contact area, each dimension of a contact has a starting point and an ending point. Due to the limit on the resolution of this type of sensor it is possible for two different contact lengths to produce the same sensor output. For example, referring to FIGS. 8a and 8b, which show a set of electrodes 102 in cross-section and planar view respectively, if Contact A starts just after the previous electrode (trace) 102 and finishes just before the next electrode 102, it will short the same number of electrodes 102 as Contact B, which has a smaller area yet still just shorts the same set of electrodes 102. The worst case one dimensional difference between the two contacts A and B can hence be 2×rₛₑₙₛₒᵣ or just below. FIGS. 8a and 8b show only one set of electrodes 102 for simplicity and this could be in the context of a sensor of the type described above in relation to FIGS. 3a and 3b. It will however be appreciated that the same principle would apply in the more complex two dimensional sensor of FIGS. 1 and 2 and the other Figures described above. The problem of limited resolution applies to any sensor with discrete and spaced out sensing elements.

FIG. 8c illustrates another problem. A very small contact represented by the black dot might cause the same sensor output as a larger contact area as illustrated by the shaded circle. FIG. 8d illustrates that the location of the small contact could be at some different location along the line of the sensor elements, as represented by the arrow and still produce the same sensor output. For a point contact, or a contact smaller than the physical resolution of the sensor then the location of the contact will often be between sensing elements. It is possible for contacts at different locations between adjacent sensing elements to produce the same sensor output. Depending on the construction of the sensor and the resilience of the sensor surface it is also possible for a small contact to appear like a larger contact area since multiple adjacent sensing elements many be activated, as illustrated in FIG. 8c where the small contact is represented by the black dot, the measured larger contact area is represented by the shaded circle and the uncertainty in the location of the contact is represented by the arrow. Therefore, the location of a small contact can sometimes only be resolved to be within 2×rₛₑₙₛₒᵣ or just below. For a well-designed sensor the location of a small contact may be resolved to be within perhaps a spacing of rₛₑₙₛₒᵣ about the location of the sensing element and centred on that location (it being assumed that when a point contact is more than ½ rₛₑₙₛₒᵣ from the sensing element then the adjacent sensing element should be triggered instead), as shown in FIG. 8d.

Although FIGS. 8a to 8d illustrate the problems discussed above in the context of a sequence of aligned linear sensing elements the same problems arise with any kind of contact sensor using discrete and separate sensor elements that produce a digital indication of the location, length and/or area of a contact on the sensor.

Since the uncertainty in measuring the location of a contact point or the starting and ending point of each dimension of a contact area equals the sensor's resolution and the location of the two end contacts across a dimension is random, the worst case error in the measurement of each dimension, Errorₘₐₓ, can be:

Errorₘₐₓ=2rₛₑₙₛₒᵣ (13)

The method proposed herein for increasing the apparent resolution of the sensor is based on the realization that when the contact length or width is in-between two traces 102 but only one trace 102 is securely shorted, the other trace 102 can make intermittent contact resulting in the sensor output flickering between two neighboring values. This is illustrated in FIG. 9. The presence of an intermittent contact is especially common when there is a human input behind the contact on the sensor, since a force applied by a person inevitably has small variations, for example due to muscular motions, breathing or heartbeat. This flickering can be used to increase the sensor resolution. FIG. 9 shows a cross-section of a contact sensor with spaced out sensing elements 102 and a conductive layer 202′ as described above in relation to FIGS. 3a and 3b. When a finger is placed on the contact sensor the conductive layer 202′ is pushed into contact with the sensing elements and shorts the sensing elements as explained above. However, the contact of the finger may cause an intermittent contact as indicated by the circles. This might be due to changes in the pressure on the conductive layer 202′, or to small movements of the finger.

The principle of operation of this example method is based on the intermittent contact that the unloaded neighboring electrodes see. This intermittent contact arises as a result of the substrate acting as a mechanical filter that spreads the load across an area that is greater than the actual contact area and because a fingertip or other contact surface may experience a small vibration (e.g. from each heartbeat), that changes the contact area, or pressure, just enough to short the unloaded electrode part of the time.

When the sensor output is stable, the measurement uncertainty equals the width of the electrode trace. When the sensor output flickers between two neighboring values then it can be assumed that one end of the contact is covering part of the space between the electrodes. The closer it is to the other electrode, the more frequent the larger measurement will be. Likewise, both ends of the contact can fall in-between electrodes. In this case, the measured contact length will flicker between three neighboring values. The uncertainty equals the width of the spacing (gap) between the two electrodes.

With equal trace and gap widths, we have:

$${Error}_{max\_enhanced} = \frac{{r}_{sensor}}{2} + \frac{{r}_{sensor}}{2} = {r}_{sensor} \qquad ( 14 )$$

So, for a sensor resolution (rₛₑₙₛₒᵣ) of 2 mm, the maximum error in measuring a contact dimension will be 2 mm, which is an improvement over 4 mm of Equation (13).

In addition, the frequency of occurrence of each value can be measured to estimate how far away or close to the next electrode the contact area is. For example, if the sensor outputs a value of 100 mm 30% of the time and a value of 102 mm 70% of the time, then it can be assumed that the contact is closer to the next electrode. One way to quantify an estimated value is to set an assumed spacing in direct proportion to the percentage of the frequency of occurrence, which this case would give an estimated value of 100 mm+0.7×2 mm=101.4 mm. The apparent sensor resolution can hence be further increased and the maximum error reduced below the value of rₛₑₙₛₒᵣ given above.

Other methods to quantify the estimated value are of course possible and may be required if it is known that, for a particular sensor structure, the relationship is not linear. Testing with known contact areas and standardised ‘vibration’ of the contact area could be used to empirically determine an appropriate relationship for particular sensor types and applications.

A sensor design that favors the use of this principle is one with very narrow electrode widths, e.g. 0.2 mm and 2 mm spacing between the traces. Using the above “frequency” principle, the position of the contact area in relation to the gap can be defined with a greater precision. The smaller the spacing between the electrodes the better. It is recommended that the spacing is ≦2 mm and preferably ≦1 mm.

FIG. 10 shows another example of a sensor array that would benefit from the approach described herein. This sensor array consists of a number of sensing elements in a grid pattern. It will be appreciated that the location and size of a contact area on this sensor array can be determined with increased resolution when the method described above is applied. Furthermore, the method can advantageously be applied to any other sensor type with discrete and spaced apart sensing elements.

The above discussion relates to the situation where the sensor produces a parameter that fluctuates in a ‘digital’ fashion between two values. In an alternative scenario the sensor may produce a parameter that varies along a continuum between the two values, which in the case of the sensor of FIG. 1 would be effectively a variable resistor producing values for the parameter that are mid-way between the values for the sensor with and without contact with an adjacent sensor element. This type of partial contact can arise with sensors of the type described above and with other sensor types. Whether a partial type contact or an intermittent type contact occurs will depend on the sensor characteristics, for example on the resistance that must be overcome to prompt a contact or on the conductivity of the conductive traces. A more conductive trace will create a better contact and is more likely to product an intermittent off/on type output. A less conductive trace may be more susceptible to a partial contact and more likely to act like a force variable resistor.

In the situation where there is a partial contact then the discussion above still generally applies, aside from the discussion relating specifically to the intermittent contact. That is to say, the sensor can still be considered to operate in the same way for a ‘normal’ contact and the location and area of a contact with respect to the sensor elements can be determined using the same methods as those described above. With the partial contact scenario, when a contact touches in-between two traces, as shown in FIG. 9 for example, the sensor will have the inner resistor step firmly shorted but the outer step will be “partially” shorted, i.e. it will act as a force variable resistor (instead of producing an intermittent contact as in FIG. 9). This means that the contact resistance R_{contact} between the shorted conductive traces on the outer step can be substantial, i.e. in the same order of magnitude as the resistive step or even greater.

FIG. 11 shows the resultant electrical circuit for a normal contact in the sensor shown in FIGS. 1 to 7. R_{contact} and R_{shorted} are connected in parallel. The total resistance of the shorted step will vary from nearly 0 Ohms (perfect electrical short, i.e. R_{contact}=0 Ohms) to R_{shorted} (very poor electrical contact, R_{contact}→∞). The actual resistance with a partial contact will be a function of how close the physical contact point is to the cross section of the silver electrodes of interest (circled in FIG. 11).

Based on the above theory, the resistive difference between each step on the sensor can be sub-divided into a number of sub-steps, for example four sub-steps as shown in FIG. 12, e.g. assuming an Rₛₜₑₚ of 40 Ohms, we create a sub step of 10 Ohms. When the measured shorted resistance (which defines the length of the contact) falls within one sub-step of the expected ideal value (e.g. number of steps×40 Ohms, assuming all Rₛₜₑₚₛ have the same value), the contact length is determined to be the number of steps that results in the expected ideal value. If the measured contact resistance falls within the second and third sub-steps between two full steps, the contact length is determined to be the number of full steps that are definitely shorted plus half a full step. E.g. in FIG. 12, if the shorted length is measured to be 409 Ohms, the number of shorted steps will be calculated to be N (409/40=10, remainder of

$$9 < \frac{Rstep}{4} ) .$$

If the sensor resistance is 425, the number of steps will be N+0.5 (425/40=10, remainder of 25, which is greater than

$$\frac{Rstep}{4}$$

and smaller than

$$3 x \frac{Rstep}{4} ) .$$

Of course, the above method does not need all Rₛₜₑₚₛ to have the same value. For uneven sensors, a different Rₛₜₑₚ value can be used for different steps. This will affect the values of the sub-steps.

For a sensor with a spatial resolution of 2 mm, when the contact is in-between two steps, the above method will measure N+0.5 steps, i.e. it will result in a 1 mm resolution. In theory, the above method can be used to detect N+0.25 steps, resulting in 0.5 mm resolution. When a measured shorted resistance falls within one sub-step j, the contact length is determined to be equal to the closest number of full steps that are definitely shorted plus the number of sub-steps up to sub-step j towards the next full step. If more sub-steps are used, a greater resolution can be achieved. In practice, the maximum resolution that can be achieved may be limited by the sensor's noise or the quality of the interface electronics. In addition, the resolution may be limited by the behavior of the sensor itself, as described below.

The above algorithm has been reduced to practice with very good performance. It has been observed that the transition of the resistance from one step to the next is not perfectly linear and in fact for the sensor of FIGS. 1 to 7 the behavior can be more typically as shown in FIG. 13. This is because the more conductive the conductive traces are, the less the force required to register a good ohmic contact, i.e. a short. Therefore, step N+1 requires very little contact force to be shorted well and the transition between no contact to full contact is very abrupt. This is a switch-like behavior. This transition can be adjusted/expanded by using conductive materials of greater resistance and/or by placing a force sensitive layer between the electrodes to make the contacts behave as force sensing resistors as opposed to metal contact switches.

In addition, the transition from one sub step to the next may not be linear. In this case, the sub-steps used in the previous examples can be of different sizes to capture the non-linear behavior described here, e.g. in the example of four sub-steps, the first step may be 5 Ohms, the second and third steps 15 Ohms and the last step 5 Ohms.

The calculation does not need to be based on just one value and in fact can be made based on a sampling of multiple values, for example 500 or 1000, with an average being taken. It will be appreciated that with this technique there are substantial similarities between the measurement of an intermittent type contact and the use of an intermediate value determined based on the time spent at first and second values, and the measurement of a partial contact and the use of an intermediate value determined as the average of a number of values over a period of time. In fact the same measurement, consisting of a number of samples taken at known frequency, can be used to determine an estimated value for either system.

While example configurations of the disclosure have been herein illustrated, shown and described, it is to be appreciated that various changes, rearrangements and modifications may be made therein, without departing from the scope of the disclosure. It is intended that the specific embodiments and configurations disclosed are illustrative of the best modes for practicing the disclosure, and should not be interpreted as limitations on the scope of the disclosure; it is to be appreciated that various changes, rearrangements and modifications may be made therein, without departing from the scope of the disclosure.

1. A method of detecting a contact using a contact sensor having an array of discrete and spaced apart sensing elements, the method comprising: measuring the value of a parameter and, when the measured value of the parameter varies between a first value and a second value with the variation being indicative of a partial and/or intermittent contact with an adjacent sensor element, determining an estimated value for the parameter intermediate the first value and the second value.

2. A method as claimed in claim 1, wherein the parameter varies by fluctuating between the first value and the second value with the fluctuation being indicative of intermittent contact at the adjacent sensor element or at adjacent sensor elements.

3. A method as claimed in claim 1, wherein the parameter takes a value in between the first value and the second value.

4. A method as claimed in claim 3, wherein the parameter varies with time, hence forming a variable value between the first value and the second value.

5. A method as claimed in claim 1, wherein the parameter varies by fluctuating between the first value and the second value with the fluctuation being indicative of intermittent contact at the adjacent sensor element and/or the parameter takes a value in between the first value and the second value, this value varying with time and forming a variable value between the first value and the second value.

6. A method as claimed in claim 5, wherein the estimated value is determined using an average of multiple sampled values of the parameter over a time period.

7. A method as claimed in claim 1, wherein the estimated value is determined using an average of multiple sampled values of the parameter over a time period.

8. A method as claimed in claim 2, wherein for a fluctuating parameter indicating intermittent contact the determination of the estimated value is based on the duration of time that the parameter spends at the first value and the duration of time that the parameter spends at the second value in a given time interval.

9. A method as claimed in claim 8, wherein the estimated value is determined by calculating a weighted mean of the first and second values of the parameter, weighted by the duration spent at the first and second values, according to the following equation:
$$〈 X 〉 = \frac{{X}_{1} {t}_{1} + {X}_{2} {t}_{2}}{{t}_{1} + {t}_{2}}$$
where <X> is the estimated value of the parameter, X₁ is the first value, X₂ is the second value, and t₁ and t₂ are the cumulative durations at each of the first and second values, respectively, during a given time interval.

10. A method as claimed in claim 8 wherein the time interval is set so as to distinguish between a moving contact and an intermittent contact.

11. A method as claimed in claim 9 wherein the time interval is set so as to distinguish between a moving contact and an intermittent contact.

12. A method as claimed in claim 4, wherein when the parameter takes the form of a variable value between the first value and the second value, the method includes taking multiple measurements of the parameter over a time period and determining the estimated value by taking an average of the measurements.

13. A method as claimed in claim 1, wherein the parameter is indicative of a length of the contact and/or is indicative of a location of a contact or of an end point of a contact area.

14. A method as claimed in claim 1, wherein the parameter is a first parameter and the method further comprises: measuring the value of a second parameter and, when the measured value of the second parameter varies between a first value and a second value with the variation being indicative of intermittent contact at adjacent sensor elements, determining an estimated value for the second parameter intermediate the first and the second value.

15. A method as claimed in claim 14 wherein the first and second parameters represent measurements in each of two co-ordinates, preferably wherein the co-ordinates are orthogonal.

16. A contact sensor apparatus comprising an array of discrete/spaced out sensing elements; and a processor; wherein the processor is arranged to measure the value of a parameter and, when the measured value of the parameter varies between a first value and a second value with the variation being indicative of partial and/or intermittent contact at adjacent sensor elements, to determine an estimated value for the parameter intermediate the first value and the second value.
